(19) United States
(12) Patent Application Publication
(10) Pub. No.: US 2012/0166356 A1
(43) Pub. Date: Jun. 28, 2012

(54) INFORMATION TERMINAL AND SALES DATA DISPLAY METHOD

(75) Inventors: Yukio Harada, Kanagawa (JP); Tomoichi Nakajo, Tokyo (JP)

(73) Assignee: TOSHIBA TEC KABUSHIKI KAISHA, Tokyo (JP)

(21) Appl. No.: 13/337,426

(22) Filed: Dec. 27, 2011

(30) Foreign Application Priority Data
Dec. 28, 2010 (JP) 2010-293247

(51) Int. Cl. G06Q 10/06

(52) U.S. Cl. 705/348

(57) ABSTRACT

An information terminal, comprising: a store selection unit for selecting a specific store, a date and time appointment unit for appointing a date and time, and a display unit for displaying a sales data in a period of time including at least one of the date and time appointed by the date and time appointment unit according to the summed sales data of the commodities displayed in the store selected by the store selection unit in the form of a time-sequence graph.

### CROSS-REFERENCE TO RELATED APPLICATION

This application is based upon and claims priority from prior Japanese Patent Application No. 2010-293247, filed on Dec. 28, 2010, the entire contents of which are incorporated herein by reference.

### FIELD

Embodiments described herein relate generally to an information terminal and a sales data display method.

### BACKGROUND

Conventionally, the shop assistants working in a supermarket or convenience store and the like replenish the stocks according to the sales data generated by a point of sale (POS) system. A POS system comprises a POS terminal for accurately calculating the sales data of the object commodities or a shop computer for registering the sales data sent from the POS terminal.

The user operates the shop computer and confirms the change in the sales of each commodity to determine whether or not to replenish the stocks of each commodity or to determine a time for replenishment. In this case, the user can predict the sales of a commodity according to the sales change of the commodity.

Besides, there is a system in which a camera is installed in a store to shoot the store every a period of time and detect the difference of the shot images in a time sequence as the sales of the commodities in the store. With this system, the user can understand the actual stocks of commodities on shelves.

In order to predict the sales of each commodity more accurately, the user needs to understand the traffic of the customers moving in the shop with some unpaid commodities in their shopping baskets.

However, in existing systems, the user cannot confirm a change in the sales of the commodities decreased in the shop. Moreover, in existing systems, it is difficult to confirm the actual situation of a store in each period of time, for example, the number of the commodities placed on shelves in each period of time.

That is, in existing systems, it is difficult for the user to understand customer traffic by comparing the actual situation of a store in each period of time with the change in sales data.

In view of the problems above, the present embodiment is disclosed, with a main object of providing an information terminal and a sales data display method for the user to understand the actual situation of a store and a sales change easily in each period of time.

### DESCRIPTION OF THE DRAWINGS

FIG. 1 is a diagram roughly illustrating the whole structure of the POS system;

FIG. 2 is a perspective view of the appearance of an information terminal, as viewed from the front side;

FIG. 3 is a perspective view of the appearance of an information terminal, as viewed from the back side;

FIG. 4 is a block diagram illustrating the electric connection of an information terminal;

FIG. 5 is a block diagram illustrating the electric connection of a shop computer;

FIG. 6 is a diagram illustrating an example of the data items constituting a master commodity table;

FIG. 7 is a diagram illustrating an example of the data items constituting a shop sales table;

FIG. 8 is a diagram illustrating an example of an image file constituting store image data;

FIG. 9 is a diagram illustrating an example of the data items constituting analysis data;

FIG. 10 is a block diagram illustrating the functions of an information terminal related to store management;

FIG. 11 is a flow chart illustrating an example of the actions of an information terminal;

FIG. 12 is a diagram illustrating an example of a display screen;

FIG. 13 is a diagram illustrating an example of a display screen;

FIG. 14 is a diagram illustrating an example of a display screen.

### DETAILED DESCRIPTION

In general according to one embodiment, a store selection unit for selecting a specific store, a date and time appointment unit for appointing a date and time, and a display unit for displaying, in the form of a time-sequence graph, the summed sales data of the commodities displayed in the store selected by the store selection unit in a period of time including at least one of the date and time appointed by the date and time appointment unit.

In general according to one embodiment, a sales data display method carried out in an information terminal which comprises a control unit and a memory unit. The sales data display method comprises the following steps that: a store selection unit selects a store; a date and time appointment unit appoints a date and time; and a display unit displays, in the form of a time-sequence graph, the sales data of the commodities displayed in the store selected by the store selection unit in a period of time including at least one of the date and time appointed by the date and time appointment unit, wherein all the steps are carried out in the control unit.

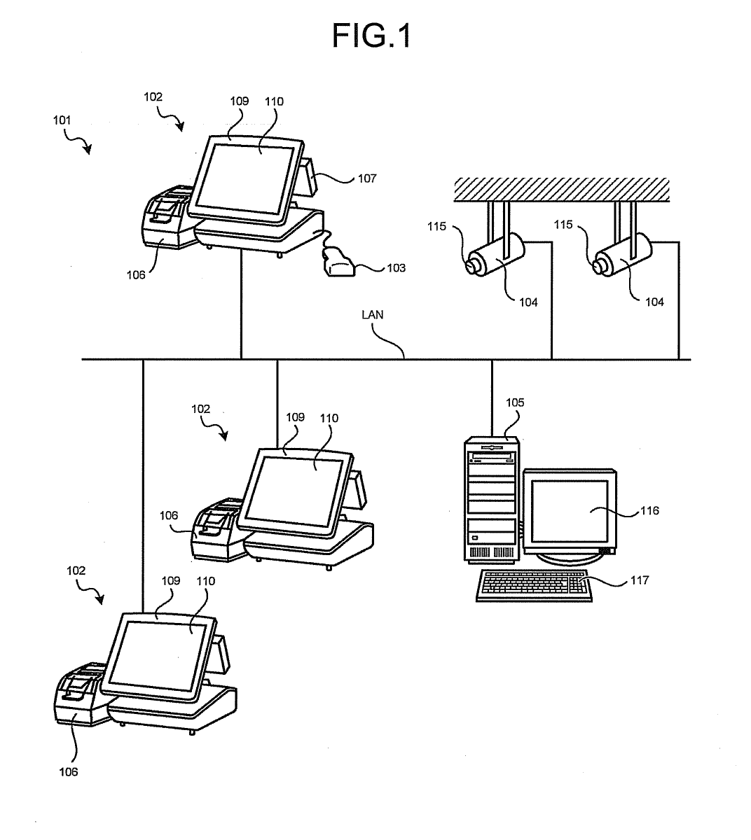

FIG. 1 is a diagram roughly illustrating the whole structure of a POS system 101 involved in the present invention. The POS terminal 101 shown in FIG. 1 comprises: an information terminal 102 installed at the checkout counter or in the back yard of a shop, a live camera 104 for shooting a store space (not shown), and a shop computer 105 set in the back yard of a shop as a server to control the whole POS system 101. Moreover, in the POS system 101, the information terminal 102, the live camera 104 and the shop computer 105 are connected with each other in a communicable manner via a communication network such as a local area network (LAN).

The information terminal 102 is a POS terminal set at a checkout counter and the like. In addition, an information apparatus can serve as the information terminal 102 that is arranged in a back yard to perform a store management such as commodity stock confirmation or sales confirmation.

The information terminal 102 is provided with a printer 106 for printing receptions, commodity stocks, commodity sales and other information, a liquid crystal display 109 for displaying various kinds of information, and a touch panel 110 for inputting an operation of a user.

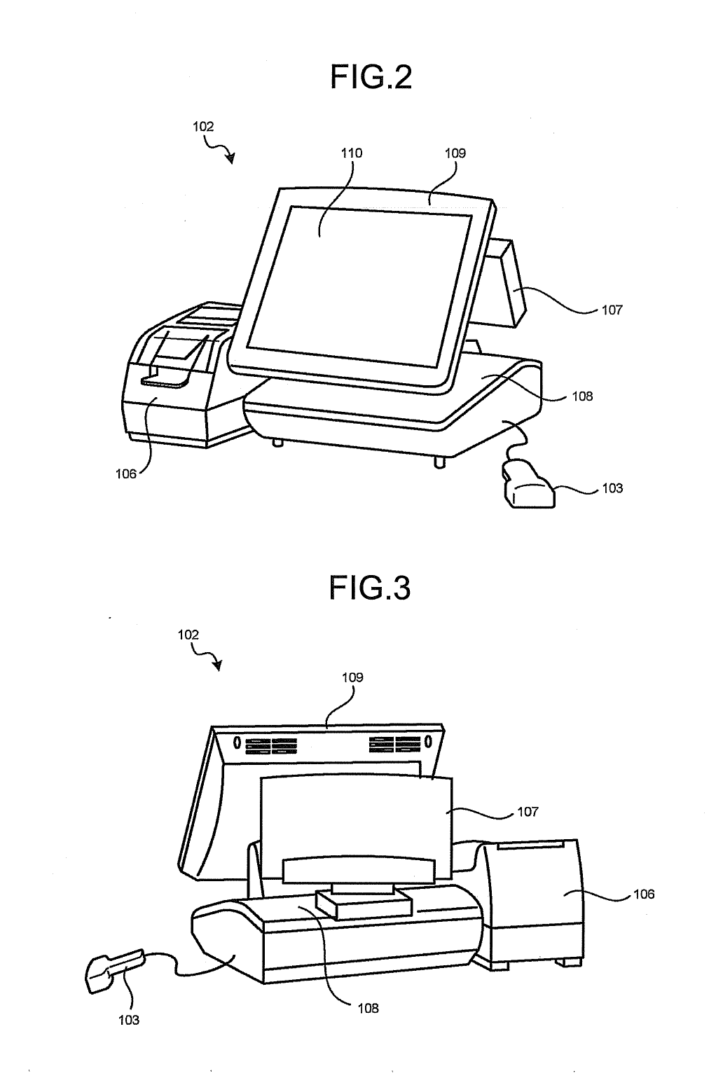

Moreover, in addition to the components above, the information terminal 102 installed at a checkout counter as a POS terminal further comprises a scanner 103 (referring to FIG. 2) for optically reading the barcodes or two-dimensional codes attached to the commodities sold in a shop and a customer-oriented display 107 (referring to FIG. 2) for displaying a payment amount for the customer at the checkout counter.

FIG. 2 is a perspective view of the appearance of the information terminal 102 serving as a POS terminal, as viewed from the front side. The information terminal 102 consists of a main body unit 108 and a liquid crystal display 109 that is placed on the main body unit 108 to serve as a display. A touch panel 110 is laminated on the display surface of the liquid crystal display 109 to serve as an input device. A printer 106 is arranged in the vicinity of the information terminal 102. The printer 106 or the scanner 103 is connected with the information terminal 102 via an interface such as universal serial bus (USB).

FIG. 3 is a perspective view of the appearance of the information terminal 102 serving as a POS terminal, as viewed from the back side. In FIG. 3, a customer-oriented display 107 is explicitly shown. One example of the customer-oriented display 107 is a seven-segment light emitting diode (LED) display. The customer-oriented display 107 is arranged above the main body unit 108 of the information terminal 12. As the printer 106 or the scanner 103, the customer-oriented display 107 is connected with the information terminal 102 via an interface such as universal serial bus (USE).

As shown in FIG. 1, the live camera 104 images the images acquired by a lens 115 on, for example, a two-dimensional CCD array (not shown). The live camera 104 is an image pickup device which carries out amplification, A/D conversion and filtering operations on the output of the two-dimensional CCD array and outputs the resulting data as animation data. The live camera 104 is arranged in each store in a supermarket to send images of goods shelves as animation data. In addition, a unique network array (e.g. IP address or MAC address) in an LAN is arranged in the live camera 104 in each store. Therefore, the information terminal 102 or the shop computer 105 can acquire, from a specific network address, the images sent by the live camera 104 installed in a specific store.

The shop computer 105, which is provided with a liquid crystal display 116 and a keyboard 117, manages the various kinds of information sent from the information terminal 102 or the animation data of each store sent by the live camera 104.

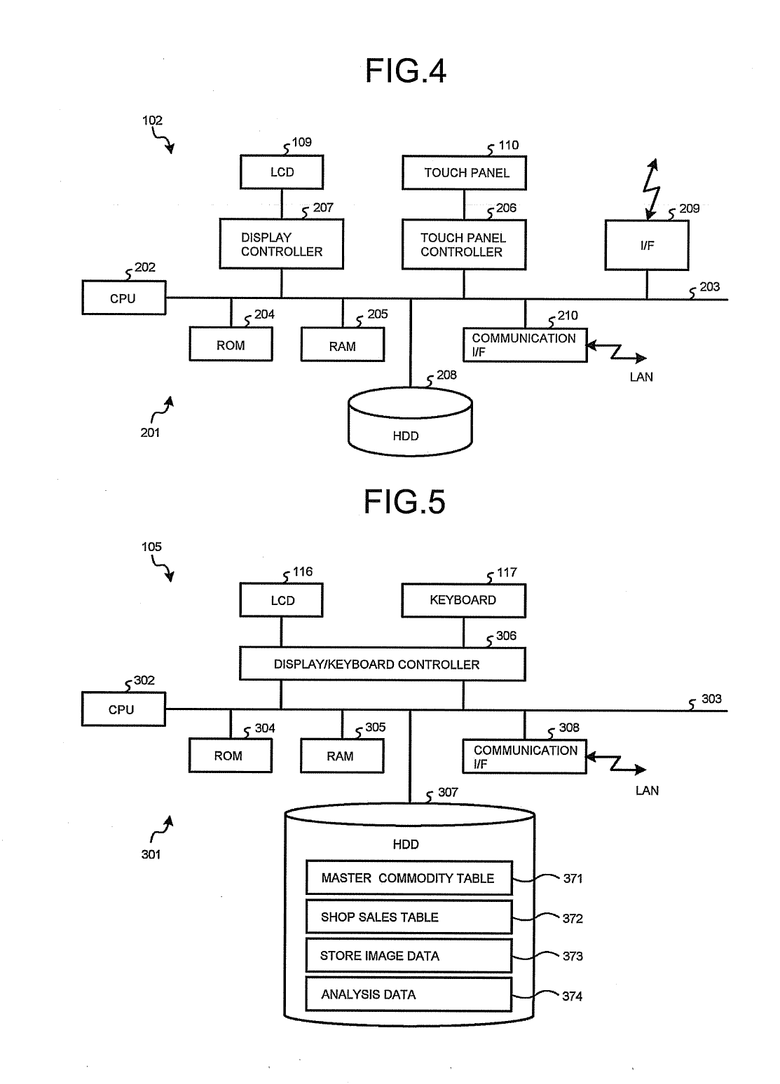

FIG. 4 is a block diagram illustrating the electric connection of the information terminal 102. As shown in FIG. 4, the information terminal 102 comprises a micro computer 201, which drives and controls the other components. The micro computer 201 is formed by connecting, via a bus line 203, a central processing unit (CPU) 202 for performing a centralized control on the other components with a read only memory (ROM) 204 in which a controlling program and other fixed information are pre-stored and a random access memory (RAM) 205 which serves as a working area to store various kinds of information during a flexible modification on the information.

A touch panel controller 206, a display controller 207, a hard disk drive (HDD) 208, an interface 209 and a communication interface 210 are connected on the micro computer 201 via the bus line 203. The touch panel controller 206 inputs a signal input from the touch panel 110 to the micro computer 201. The display controller 207 drives and controls the liquid crystal display 109 according to image data and displays, on the liquid crystal display 109, an image in response to the image data. The interface 209 is an interface for connecting the scanner 103, the printer 106 and the customer-oriented display 107 with the micro computer 201. As mentioned above, the interface 209 is a USB. The communication interface 210 is an interface enabling the micro computer 201 to carryout a data communication with other devices via an LAN.

The HDD 208 stores an operating system (OS), computer programs (hereinafter referring to program) and various files. When the information terminal 102 is started, the OS, the program and the various files are completely or partially copied into the RAM 205 and then accessed by the CPU 202. The CPU 202 executes the processing of the coped OS and program (e.g. sales registration or store management).

FIG. 5 is a block diagram illustrating the electric connection of the shop computer 105. As shown in FIG. 5, the shop computer 105 comprises a micro computer 301, which drives and controls the other components. The micro computer 301 is formed by connecting, via a bus line 303, a CPU 302 for performing a centralized control on the other components with an ROM 304 in which controlling program and other fixed information are pre-stored and an RAM 305 which serves as a working space to store various kinds of information during a flexible modification on the information.

In the micro computer 301, a display/keyboard controller 306, an HDD 307 and a communication interface 308 are connected via the bus line 303. The display/keyboard controller 306 drives and controls the liquid crystal display 116 according to image data and displays, on the liquid crystal display 116, an image in response to the image data. Moreover, the display/keyboard controller 306 inputs a signal input from the keyboard 117 to the micro computer 301. The communication interface 308 is an interface enabling the micro computer 301 to carry out a data communication with other devices via an LAN.

The HDD 307 stores an OS, a program and various files. When the shop computer 105 is started, the OS, the program and the various files are completely or partially copied into the RAM 305 and then accessed by the CPU 302. The CPU 302 executes the processing of the copied OS and program.

The various files stored in the HDD 307 include a master commodity table 371, a shop sales table 372, store image data 373 and analysis data 374. The master commodity table 371 stores the data related to the commodities processed in a shop. The master commodity table 371 processes the data that is preset according to the settings of the information terminal 102 and is taken as a reference for the information terminal 102 serving as a POS terminal to register sales. The shop sales table 372, which stores the data related to the sales of a shop, updates the data related to sales through the sales registration carried out by the information terminal 102 serving as a POS terminal. The store image data 373 serving as shot data stores the store images (animation data) that are shot by the live camera 104 set in each store according to a schedule and then sent by the live camera 104. The analysis data 374 stores the result of an analysis carried out by the shop computer 105.

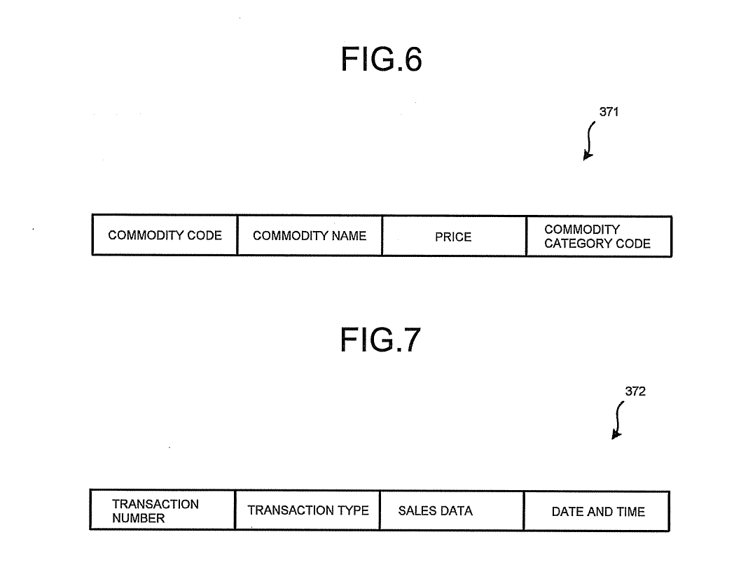

FIG. 6 is a diagram illustrating an example of the data items constituting the master commodity table 371. As shown in FIG. 6, the master commodity table 371 is composed of records consisting of data items including commodity code, commodity name, price, commodity category code. Here, the commodity code is a fixed code preset for a commodity item in the shop to provide commodity identification. Moreover, the commodity name, the price and the commodity category code are information on the commodity specified by the same commodity code. The commodity category code is a code representing the category of commodities (e.g. the large-category or small-category of different commodity items) in each store. Therefore, it can be determined, with reference to a commodity category code, which store a commodity with a specific commodity code is sold from.

FIG. 7 is a diagram illustrating an example of the data items constituting the shop sales table 372. As shown in FIG. 7, the shop sales table 372 is composed of records consisting of data items ‘transaction number’, ‘transaction type’ and ‘sales data’ sent by the information terminal 102 in a shop during a sales registration and a data item storing ‘registration date and time’, wherein the information terminal 102 serves as a POS terminal. Based on the data item ‘date and time’, the CPU 302 sum, daily or every a period of time, the sales data registered in the shops sales table 372 according to the requirement of the information terminal 102 or at regular times (e.g. once a day). The summed sales data is sent to a high-end server (not shown) installed in the head quarter of the shop or the information terminal 102 requiring the sending. In addition, the sales data can also be summed in the information terminal 102 daily or every a time interval. Specifically, the CPU 302 sends the sales data registered in the shop sales table 372 to the information terminal 102 according to a requirement from the information terminal 102, and the sales data is summed daily or every a time interval in the information terminal 102, based on the data item ‘date and time’.

The sales registration is described here that is carried out by the information terminal 102. During a sales registration, the CPU 202 stores the commodity code input by the scanner 103 to the working area of the RAM 205. Moreover, the CPU 202 stores the transaction type and the sales volume sold input from the touch panel 10 to the working area of the RAM 205. Here, transaction types include, for example, normal transaction, discounted transaction and credit card payment.

Moreover, by retrieving the master commodity table 371 stored in the shop computer 105 according to the information stored in a working area, the CPU 202 can acquire a sales price or commodity name to generate sales data based on a commodity code, a sales volume, a commodity name and a sales price. Then, the CPU 202 repeatedly calculates the total sales every time a commodity is input until an operation indicating a transaction settlement is input (for instance, the small button ‘sum’ on the touch panel 110 is pressed down). When a transaction settlement is indicated, the CPU 202 informs the shop computer 105 of the sales data of each transaction together with a transaction number for identifying the current transaction and an input transaction type. The shop computer 105 registers the sales data, the transaction number and the transaction type informed by the information terminal 102 into the shop sales table 372.

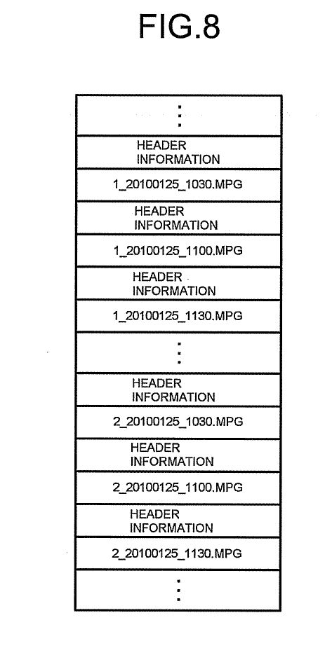

Then, store image data 373 is described below. Index files and animation data files (e.g. shot data in Moving Picture Experts Group (MPEG format) that are shot by each live camera 104 at different preset positions are stored in the store image data 373 by date. FIG. 8 is a diagram illustrating an example of an image file constituting the store image data 373. As shown in FIG. 8, an image file consists of successive header information and animation data files. The header information includes image-related information (fixed camera position) and image acquisition time. On the other hand, for the sake of a high-speed display, the index file can only store the header information. That is, in the store image data 373, an animation data file including a store image (animation data) is recorded in each period of time according to a time sequence, wherein the store image serves as the image data that is shot by the live camera 104 installed in each store and then sent by the live camera. Specifically, in the former animation data file, the first number represents the category code of commodities (e.g. large-category or small-category of different commodity items) in a store, the numbers following the first underline represent a shooting date, and the numbers following the second underline represent the name of a file that is named by a shooting time and records the animation data of a shot store. Taking the animation data file ‘1_{—}20100125_{—}1030.mpg’ shown in FIG. 8 as an example, the commodity code ‘1’ (that is, the first number) represents a store for, for example, home style dishes, ‘20100125’ represents a shooting date: Jan. 25, 2010, and ‘1030’ representing a shooting time: 10:30. The CPU 302 acquires, every a given period of time (e.g. 30 minutes), the animation data sent by the live camera 104 installed in each store, names the animation data with the file name above, and then stores the named animation data in the store image data 373. Therefore, the animation data of each store in a period of time can be acquired with reference to the filename of the animation data stored in the store image data 373; however, in this embodiment, for the sake of a high-speed display, the animation data of each store (the live camera 104) in a period of time can be acquired with reference to an index file.

In addition, in this embodiment, the image of each store during each period of time is orderly recorded as an element of an animation data file. Even in this case, the still image of each store during each period of time can be acquired from a designated frame position.

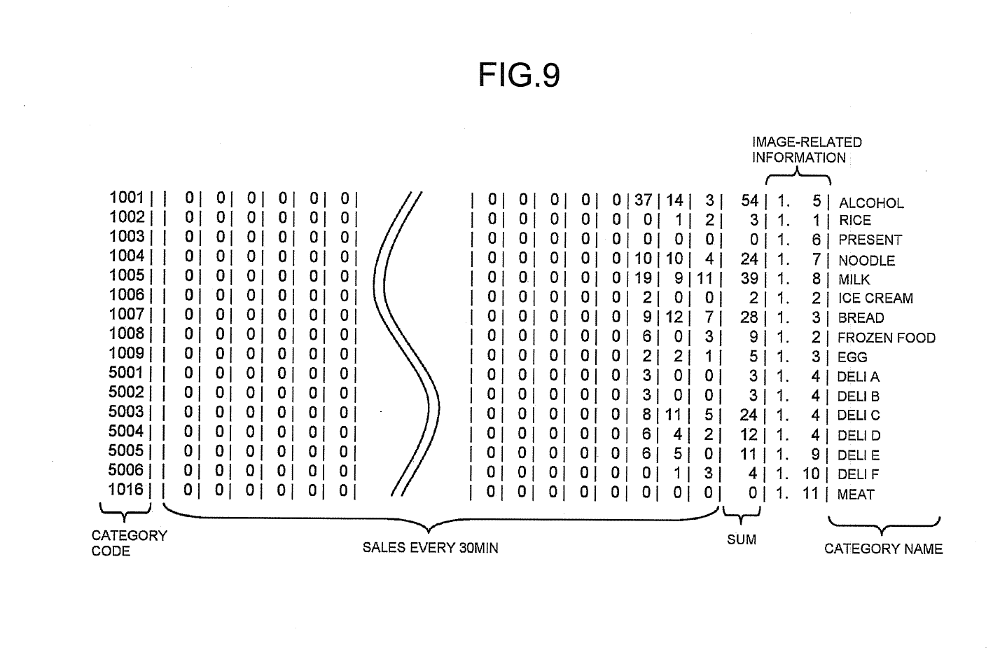

Then, the analysis data 374 is described below. In the shop computer 105, the analysis data 374 is generated using the sales data that is informed by the information terminal 102 and registered in the shop sales table 372. The analysis 374 is in the data format shown in FIG. 9. As shown in FIG. 9, the analysis data 374 makes a category code representing the large-category or small-category of different commodity items, a category name corresponding to a small-category and the image-related information (a fixed camera position) of the live camera 104 shooting a store (large-category or small-category of different commodity items) corresponding to a commodity category code correspond with the sales of each category code in a unit time ‘30 m’ and a summed sales.

In addition, the shop computer 105 carries out an analysis processing when it is needed to acquire and update log data (the sales data registered in the shop sales table 372), no matter whether or not there is the analysis data 374.

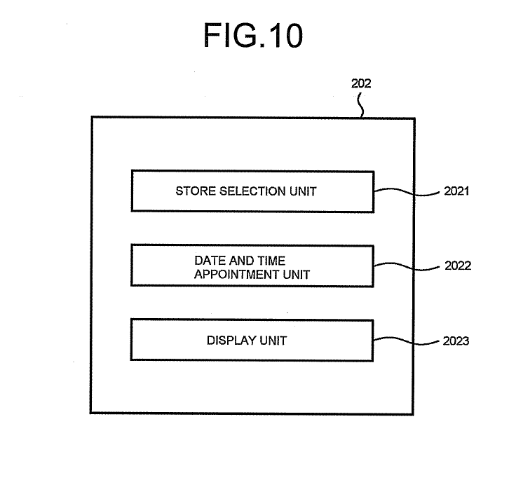

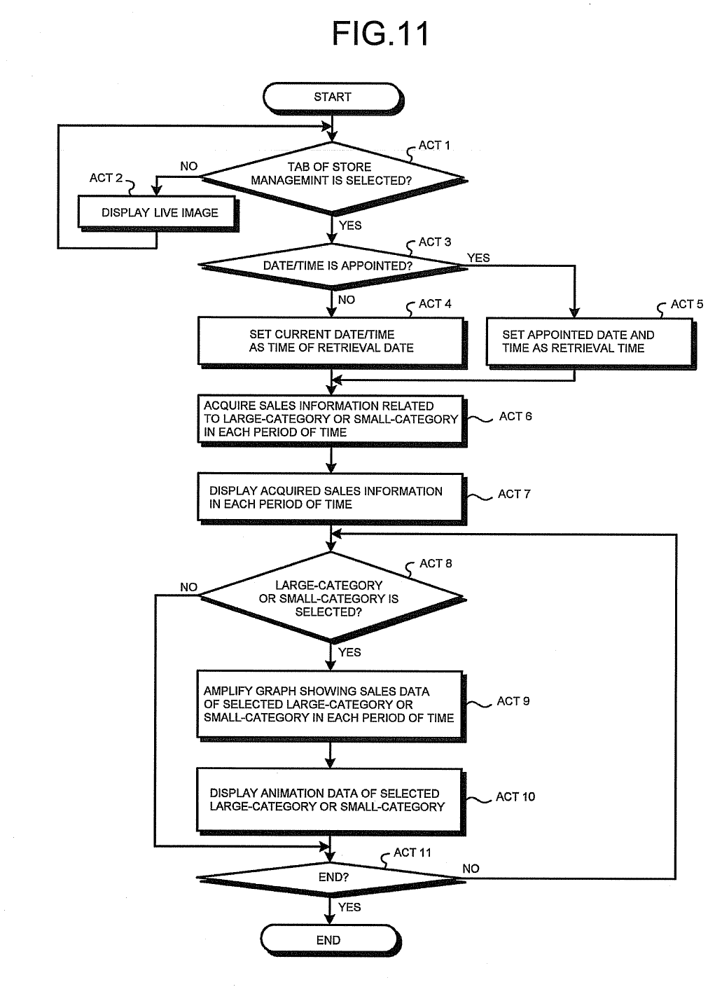

Then, an example of the actions of the information terminal 102 carried out by the CPU 202 according to the program stored in the HDD 208 is described with reference to the functional block diagram shown in FIG. 10 and the flow chart shown in FIG. 11. More specifically, a series of actions are described that are carried out to display a display screen related to store management on the liquid crystal display 109.

As shown in FIG. 10, the CPU 202 realizes a store selection unit 2021, a date and time appointment unit 2022 and a display unit 2023 by executing related programs.

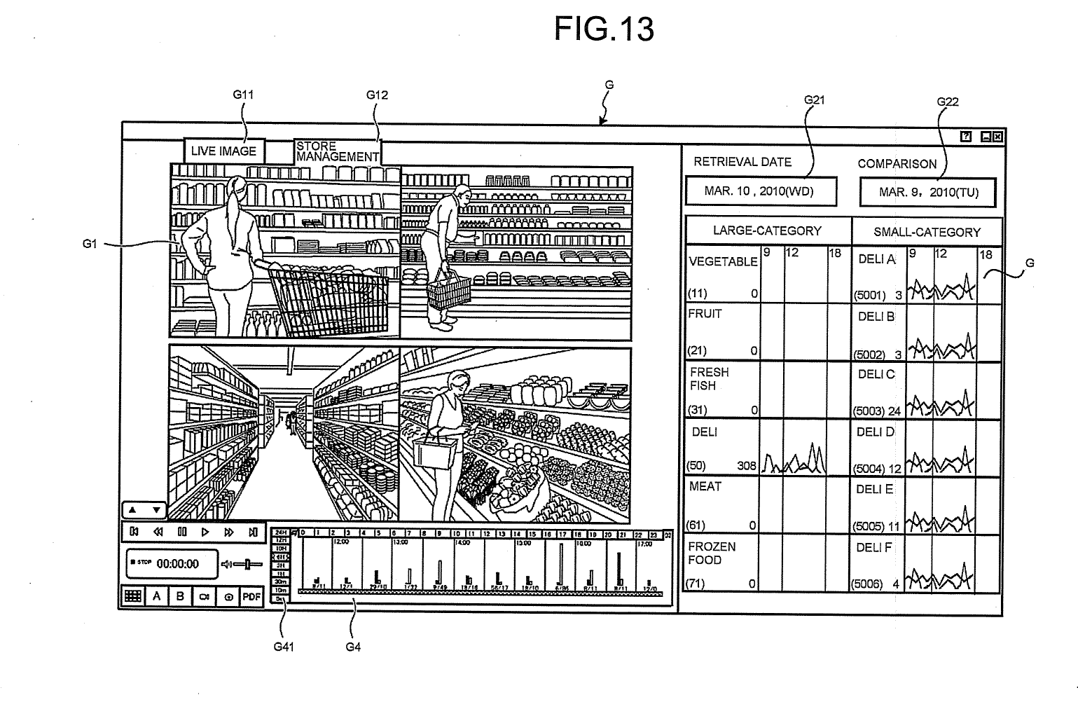

The store selection unit 2021 selects a specific store. Specifically, the CPU 202 takes large-category or small-category that is selected on the sales display window G2 (referring to FIG. 13) based on an operation on the touch panel 110 as a selected store.

The date and time appointment unit 2022 appoints a time of a retrieval date serving as a retrieval standard and a time of a comparison date serving as a comparison object of the retrieval date. Specifically, the CPU 202 can appoint a date and time by operating the figure buttons (not shown) on the touch panel 110 or by touching a date and time appointment menu that will be described in detail latter. If no retrieval date or comparison date is appointed, the CPU 202 sets the current date as a retrieval date serving as a retrieval standard and the current time as the time of the retrieval date; if a retrieval date and a comparison date are appointed, the CPU 202 sets the current time as the time of the retrieval date and the time of the comparison date.

The display unit 2023 displays, in the form of a time-sequence graph, the summed sales of the commodities displayed in the store selected by the store selection unit 2021 in a period of time including the at least one date and time appointed by the date and time appointment unit 2022. Moreover, the display unit 2023 displays an image (animation data) of a store selected by the store selection unit 2021 or an image (animation data) that is shot by the live camera 104 installed in a store according to a time sequence in a period of time including the at least one date and time appointed by the date and time appointment unit 2022.

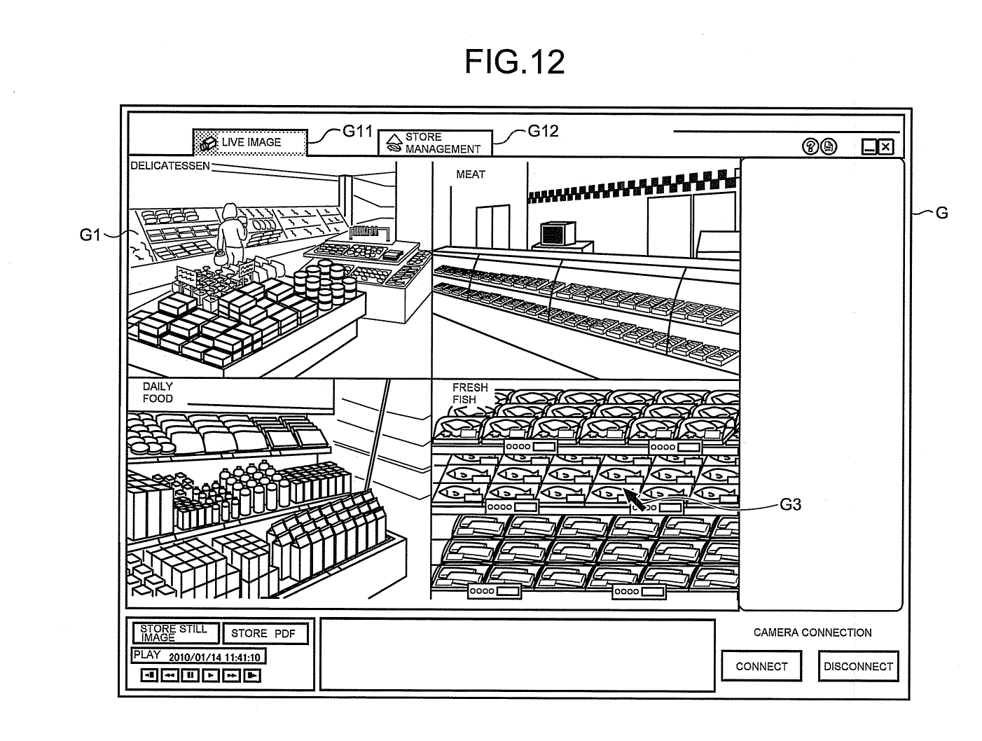

As shown in FIG. 11, before store management is started, a display screen related to store management is displayed on the liquid crystal display 109, the CPU 202 determines whether or not the menu ‘store management’ (referring to FIG. 12) displayed on the display screen is selected through an operation on the touch panel 110.

FIG. 12 is a diagram illustrating an example of a display screen G. The display screen G is a display screen that is related to store management and displayed on the liquid crystal display 109 during store management. As shown in FIG. 12, an information window G1 and a cursor G3 are displayed in the display screen G.

The information window G1 is a window, on the top of which there is a tab G11 and a tab G12, and in which the information corresponding to the tab selected by the cursor G3 is displayed. The tab G11 is a tab for displaying the animation data showing a live store image in the information window G1. The tab G12 is a store management tab for displaying the information related to store management in the information window G1, a sales display window G2 or a sales display amplification window G4 (referring to FIG. 13). In the example shown in FIG. 12, the tab G11 is selected, and animation data displayed in the information window G1 that shows the live image of each store (store for delicatessen, meat, daily food and fresh fish) where a live camera 104 is installed. The cursor G3 moves on the display screen G in response to a touch operation on the touch panel 110.

Returning to FIG. 11, if the store management tab G12 is not selected through the touch panel 110 in Act 1, that is, the tab G11 is selected to display a live image, then, the CPU 202 acquires the animation data that is sent by the live camera 104 installed in each store as a live store image and displays the acquired animation data in the information window G1 (Act2). After Act 2 is carried out, the flow returns to Act 1. Therefore, live images are continuously displayed during the period in which the tab G11 is selected.

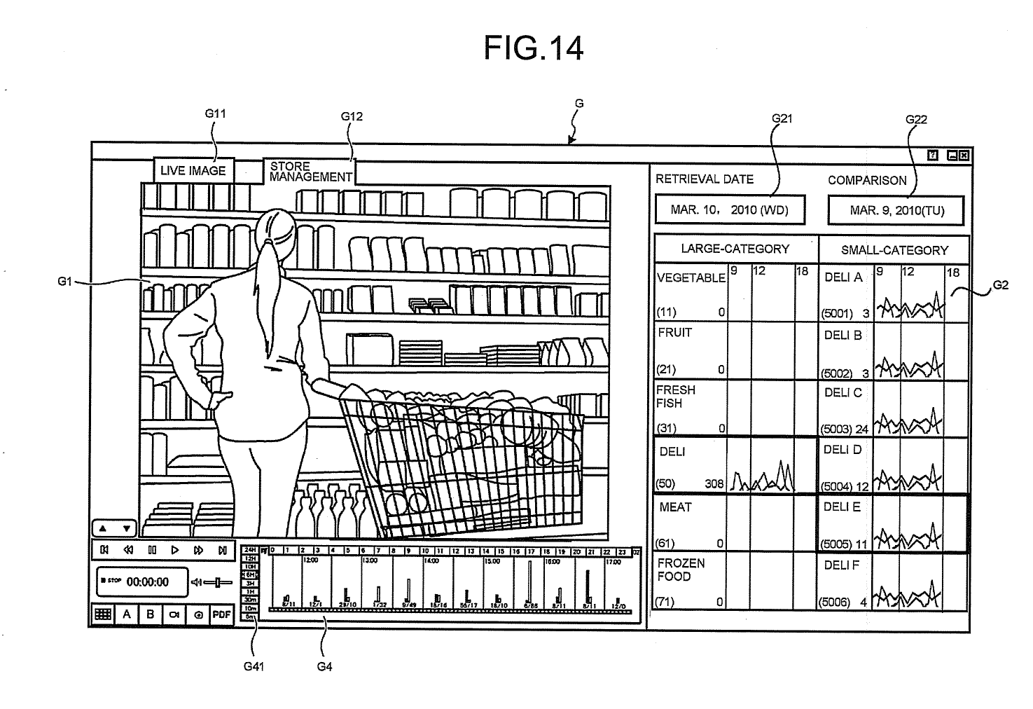

In the case where the store management tab G12 is selected via the touch panel in Act 1 (Yes), the CPU 202 (the date and time appointment unit 2022) determines whether or not a date and time is appointed via the touch panel 110 (Act 3). A date and time can also be appointed by operating the figure buttons (not shown) on the display screen G via the touch panel 110 or by touching date and time appointment menus G21 and G22 (referring to FIG. 13 and FIG. 14).

In the case where no date is appointed as a retrieval date or a comparison date (Act3: No) and no time is appointed as the time of a retrieval date or a comparison date, the CPU 202 (the date and time appointment unit 2022) sets the current date as a retrieval date serving as a retrieval standard and the current time as the time of the retrieval time (Act4). In the case where a retrieval date and a comparison date are appointed and the times of the retrieval date and the comparison date are appointed (Act3: Yes), the CPU 202 (the date and time appointment unit 2022) sets the appointed dates and the appointed times (set the current time as the time of the retrieval date and the current time as the time comparison date) (Act 5). In addition, in the case where only one date and one time are appointed by the CPU 202 (date and time appointment unit 2022), the CPU 202 sets the appointed date as a comparison date and the current time as the time of the comparison date, and synchronously sets the current date as a retrieval date serving as a retrieval standard and the current time as the time of the retrieval date.

Then, based on the appointed date and time, the CPU 202 acquires the sales information (sales data) related to large-category or small-category in a period of time (Act 6). Specifically, the CPU 202 acquires analysis data 374 from the shop computer 105 based on the appointed date and time, and extracts the sales data related to the commodity category (large-category or small-category) code contained in the analysis data 374 in a period of time including the appointed date and time.

Then, the CPU 202 (the display unit 2023) displays the acquired sales information (sales data) related to large-category or small-category in each period of time on a display screen G (Act 7).

FIG. 13 is a diagram illustrating an example of the display screen G. As shown in FIG. 13, the acquired sales information related to large-category or small-category in each period of time is displayed in a sales display window G2 in the display screen G in graph form (bar graph or line graph). In the case where two dates are appointed, that is, a retrieval date and a comparison date are appointed, as sales information related to large-category or small-category displayed in the sales display window G2 in each period of time, the CPU 202 (display unit 2023) displays the sales information of the appointed dates (retrieval date and comparison date), respectively.

Moreover, in the case where one date, that is, a comparison date, is appointed, the CPU 202 (display unit 2023) displays the sales information of the appointed date (comparison date) and the sales information of the current date. Moreover, in the case where no date and time is appointed, the CPU 202 (display unit 2023) only displays the sales information of the current date. That is, the CPU 202 (display unit 2023) displays, on the tab of the appointed date, the sales information on a plurality of dates in an overlapped manner according to a time sequence.

When the sales display window G2 is displayed in this way, the CPU 202 (display unit 2023) determines whether or not the large-category or small-category displayed on the sales display window G2 is selected by operating the touch panel 110 (Act 8). If no large-category or small-category is selected (Act 8: No), the CPU 202 waits for a selection on a large-category or small-category until the processing is ended (Act 11: Yes).

If the CPU 202 (store selection unit 2021) determines that a large-category or small-category is selected (Act 8: Yes), the CPU 202 (display unit 2023) amplifies the graph (e.g. spline graph) representing the sales of the selected large-category or small-category in each period of time and displays the amplified graph in the sales display amplification window G4 in the display screen G (Act 9).

Besides, if a large-category is selected, the CPU 202 (display unit 2023) performs a switching to the small-categories displayed in the sales display window G2. That is, the CPU 202 unfolds the sub-categories of the selected store (large-category) and displays the sales graphs of the sub-categories. Moreover, the CPU 202 (display unit 2023) changes the time range of the sales display amplification window G4 according to a scale G41. For instance, the time range of the scale is set to be 5 m, 10 m, 30 m, 1 h, 3 h, 6 h, 10 h, 12 h and 24 h. When the time range of the scale is reduced, detailed data can be referred, and when the time range of the scale is increased, the sales achieved at morning, afternoon and night can be compared.

Moreover, based on the appointed date and time, the CPU 202 (display unit 2023) displays the animation data of the store (the large-category or small-category selected in Act 8) in each period of time in the information window G1 (Act 10).

FIG. 14 is a diagram illustrating an example of the display screen G. The CPU 202 (display unit 2023) acquires sales image data 373 from the shop computer 105 and refers to the index file recorded in the sales image data 373 so as to extract, based on the appointed date and time, the animation data in a specific time range from an image file related to the selected large-category or small-category. Moreover, as shown in FIG. 14, the extracted animation data is displayed in the information window G1 in the display screen G. More specifically, image-related information (fixed camera position) of the live camera 104 shooting the store (serving as the selected large-category or small-category) is acquired from the analysis data 374, and index files are retrieved based on the acquired image-related information (fixed camera position) and the appointed date and time, thereby extracting the animation data file of the specific time range component.

In the example shown in FIG. 14, the animation data of the animation data file ‘2010/01/2510:30’ retrieved based on the appointed date and time is regenerated in the information window G1. The animation data shows an image of a store every 30 minutes. Therefore, the user can confirm the stocks of the commodities on the shelves every 30 m during the period from ‘2010/01/2510:30’ to ‘2010/01/2518:00’. In addition, the displayed in this figure is only an example, and proper modifications can be devised based on the position where the animation data is displayed.

As mentioned above, in the display screen G, the image of the selected store (large-category or small-category) in each period of time is displayed in the information window G1, and the sales information of the selected store (large-category or small-category) in each period of time is displayed in the sales display amplification window G4. Therefore, according to the image (animation data) of a store in each period of time, the user can confirm the sales of, the store in each period of time and the current situation of the store such as the stocks of the commodities on shelves. The sales that is achieved in each period of time and displayed in the sales display amplification window G4 is summed data, and the animation data displayed in the information window G1 is the image of a store in each period of time, which shows the current situation of the store. Moreover, the information window G1 and the sales display amplification window G4 can be displayed in the same display screen G, which facilitates a comparison. Thus, by comparing the sales that is achieved in each period of time and displayed in the sales display amplification window G4 with the image (animation data) of the store displayed in the information window G1 in each period of time, the user can intuitively understand the traffic of the customers moving in the shop with unpaid commodities in their shopping basket, and the like. In this way, by understanding the traffic of the customers moving in the shop with unpaid commodities in their shopping basket, the user can accurately predict the sales of commodities, thus reducing the sales loss due to the lack of commodities on shelves and the number of the commodities that are discarded before sold.

Moreover, as the sales information of the current date and the sales information of an appointed date are displayed in the graph of the appointed date and time in an overlapped manner according to a time sequence, the sales achieved a week ago can be compared with that achieved the current day to realize a revitalization of the shop, a timely produce of the shop and a good selection of commodities.

Then, the CPU 202 determines whether or not to end the processing by determining whether or not a processing ending operation is input via the touch panel 110 (Act 11). If a processing ending operation is input via the touch panel 110 (Act 11: Yes), the CPU 202 ends the processing, otherwise (Act 11: No), the CPU 202 returns to execute Act 8 to continue to select a large-category or small-category.

In addition, the program executed in the information terminal 102 provided in this embodiment is programmed in the HDD 208 or ROM 204 in advance, or stored in a computer-readable memory medium such as CD-ROM, floppy drive (FD), CD-R, digital versatile disk (DVD) as an installable or executable file.

Moreover, the program executed in the information terminal 102 provided in this embodiment may be stored in a computer connected with the Internet and downloaded from a network to be used. The program executed in the information terminal 102 provided in this embodiment may be provided or allocated via the Internet or other networks.

In this embodiment, The program execution in the information terminal 102 leads to the forming of modular components including the aforementioned units (store selection unit 2021, date and time appointment unit 2022, display unit 2023); actual hardware reads programs from the ROM 202, ROM 204 or HDD 208 via the CPU 202 and executes the programs so as to carry the aforementioned units on a master memory device (RAM 205) and generate the store selection unit 2021, the date and time appointment unit 2022 and the display unit 2023 on the master memory device.

Moreover, although in this embodiment, a processing is exemplarily carried out by an information terminal 102 installed at the checkout counter or in the back yard of a shop, it should be appreciated that the processing carried out by the information terminal 102 or shop computer 105 may also be carried out by other servers, for example, a high-end server installed in the head quarter of the shop, and the latter situation is not described here.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information terminal, comprising:
a store selection unit for selecting a specific store;
a date and time appointment unit for appointing a date and time; and
a display unit for displaying a sales data in a period of time including at least one of the date and time appointed by the date and time appointment unit according to the summed sales data of the commodities displayed in the store selected by the store selection unit in the form of a time-sequence graph.

2. The information terminal according to claim 1, wherein
in the case where the data and time appointment unit appoints at least two dates and times, the display unit overlaps and displays the sales data in the periods of time including the appointed dates and times in a graph form.

3. The information terminal according to claim 1, wherein
in the case where the commodities displayed in the store selected by the store selection unit include sub-categories, the display unit displays still more the sales data of the sub-categories in a period of time including at least one of the date and time appointed by the date and time appointment unit in the form of a time-sequence graph.

4. The information terminal according to claim 1, wherein
the display unit displays a animation data in a time sequence in a period of time including at least one of the date and time appointed by the date and time appointment unit according to the animation data of the store selected by the store selection unit or the animation data that is shot by a store shooting camera.

5. The information terminal according to claim 1, wherein
the display unit displays the sales data in a period of time including at least one of the date and time appointed by the date and time appointment unit in the form of a time-sequence graph, and also displays another graph which amplify the graph.

6. The information terminal according to claim 1, wherein
when displaying the sales data in a period of time including at least one of the date and time appointed by the date and time appointment unit in the form of a time-sequence graph, the display unit can change the time range of the scale of the graph.

7. The information terminal according to claim 1, wherein
the date and time appointment unit appoints the time of an object date as an object time.

8. The information terminal according to claim 1, wherein
the display unit displays, on the same screen, an area showing the animation data of the store selected by the store selection unit in each period of time and an area showing the sales data of the store selected by the store selection unit in each period of time.

9. A sales data display method carried out in an information terminal, wherein
the information terminal comprises a control unit and a memory unit, carried out in the control unit; further includes
a store selection unit selects a specific store;
a date and time appointment unit appoints a date and time; and
a display unit displays a sales data in a period of time including at least one of the date and time appointed by the date and time appointment unit according to the summed sales data of the commodities displayed in the store selected by the store selection unit in the form of a time-sequence graph.

10. The sales data display method according to claim 9, wherein
the display unit displays, on the same screen, an area showing the animation data of the store selected by the store selection unit in each period of time and an area showing the sales data of the store selected by the store selection unit in each period of time.
